(19) United States
(12) Patent Application Publication
(10) Pub. No.: US 2010/0011405 A1
(43) Pub. Date: Jan. 14, 2010

(54) Method and Apparatus for Audio Selection

(75) Inventor: Jing WU, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 12/171,077

(22) Filed: Jul. 10, 2008

(51) Int. Cl. H04N 7/173

(52) U.S. Cl. 725/131

(57) ABSTRACT

Method and apparatus for providing alternate audio data for a received broadcast media stream. In one embodiment, a method may include receiving a broadcast media stream including video data and audio data and detecting a channel setting of the receiving device, wherein the channel setting includes audio data associated with a channel of the broadcasted media stream. The method may further include detecting an audio setting associated with the channel of the broadcast media stream, wherein the audio setting corresponds to a user preferred audio data for the channel and outputting the video data and the audio data of the received broadcast media stream based, at least in part, on the user preferred audio data.

### FIELD OF THE INVENTION

The present invention relates in general to receiving devices and more particularly to a method and apparatus for audio language selection.

### BACKGROUND

Digital video and audio coding technologies, such as the Advanced Television Systems Committee (ATSC) digital television (DTV) standard, have contributed to a shift in conventional methods of creating, delivering, and consuming audio/visual content. A feature of the ATSC DTV standard allows for multiple audio channels within the same broadcast stream. In essence, audio channels of a DTV broadcast may provide a variety of audio services. For example, an audio channel may include digital audio data for music and sound effects. Similarly, other channels may provide dialogue in one or more languages. Further, many nations have and continue to adopt digital standards for transmission of media. In order for users to utilize features of DTV services, receiving devices require configurations that will allow users to access these services.

Current broadcasting standards, such as the ATSC DTV standard, allow for multiple languages to be broadcast to receiving devices. For example, channels of a broadcast media stream may be transmitted in a particular spoken language, such as English, French, Spanish, etc. Typically, a user device for receiving media broadcasts decodes a single language of received media data. Further, broadcasters generally transmit a single audio language for a particular channel of a broadcast media stream. The single audio language is generally audio data for a language the broadcasted media is recorded in. While these standards allow for multiple languages to be transmitted with media, the prior art methods and systems for receiving broadcast data typically do not process such information. As such, some broadcasters employ dubbing to mix a single audio language data with video data to provide media content in a second language prior to transmission. Further, channels are usually programmed for a particular spoken language. However, the ATSC DTV standard allows for channels of broadcasted media to include a plurality of spoken languages for each channel. Yet, the prior art receiving systems are limited in their ability to provide such data to users of broadcast receiving devices.

In addition, the prior art receiving systems do not address storing and/or utilizing user language preferences for channels. As such, users of prior art receiving systems are required to manually configure settings of a device for receiving broadcast media streams. As a result, the experience for some users may be diluted. Further, users may be less inclined to view particular channels due to language options available. As such, there is need for a method and apparatus for to allow users to select audio data associated with one or more spoken languages.

### BRIEF SUMMARY OF THE INVENTION

Disclosed and claimed herein are methods and apparatus for providing alternate audio data for a received broadcast media stream. In one embodiment, a method includes receiving a broadcast media stream comprising video data and audio data and detecting a channel setting of the receiving device, wherein the channel setting comprises audio data associated with a channel of the broadcasted media stream. The method further includes detecting an audio data setting associated with the channel of the broadcast media stream, wherein the audio data setting corresponds to user preferred audio data for the channel and outputting the video data and the audio data of the received broadcast media stream based, at least in part, on the user preferred audio data.

Other aspects, features, and techniques of the invention will be apparent to one skilled in the relevant art in view of the following detailed description of the invention.

### BRIEF DESCRIPTION OF THE DRAWINGS

FIG. 1 depicts a simplified block diagram of a receiving device according to one or more embodiments of the invention;

FIG. 2 depicts a simplified system diagram according to one or more embodiments of the invention;

FIG. 3 depicts a process for providing audio data according to one or more embodiments of the invention;

FIG. 4 depicts a process for providing audio data according to one or more embodiments of the invention; and

FIG. 5 depicts a graphical representation of an exemplary broadcast media stream according to one or more embodiments of the invention.

### DETAILED DESCRIPTION OF EXEMPLARY EMBODIMENTS

The present disclosure relates generally to receiving broadcast media and more particularly to methods and devices configured to select alternate audio channels of a received broadcast media stream. As will be described in more detail below, one or more audio languages of a received broadcast media stream may be processed by a receiving device. Data corresponding to one or more languages of the received broadcast media stream may be encoded into different channels. According to another embodiment, particular channels of a received broadcast media stream may be flagged for a particular audio language provided by the broadcast media stream. The receiving device may be configured to decode audio data based on at least one user preference. In that fashion, alternate audio streams may be provided over one or more channels in accordance with user-defined preferences. Receiving devices, as described herein, may relate to one or more of a middleware device, display device and broadcast media receiving device in general. It may also be appreciated that one or more processes may be provided to configure audio settings of the receiving device.

In another embodiment, a process may be provided for decoding audio languages within a received broadcast media stream based, at least in part, on one or more user preferences. Similarly, decoding received media may be based on detected languages encoded in the broadcast media stream. In one embodiment, user preferences may be entered using menu options of the receiving device, user requested settings and/or learned settings by the receiving device. Receiving devices may present media based on at least one user preference. Further, processes may be provided to retrieve alternate audio data for received broadcast media. Additional details and features of the exemplary embodiments are described below.

When implemented in software, the elements of the invention are essentially the code segments to perform the necessary tasks. The program or code segments can be stored in a processor readable medium. The “processor readable medium” may include any medium that can store information. Examples of the processor readable medium include an electronic circuit, a semiconductor memory device, a ROM, a flash memory or other non-volatile memory, a floppy diskette, a CD-ROM, an optical disk, a hard disk, a fiber optic medium, etc. The code segments may be downloaded via computer networks such as the Internet, Intranet, etc.

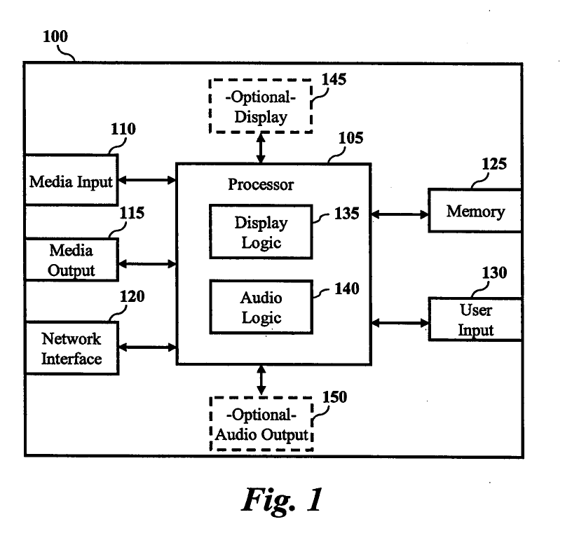

Referring now to the drawings, FIG. 1 is a simplified block diagram of a receiving device according to one or more embodiments of the invention. In one embodiment, receiving device 100 may relate to one of a display device and middleware device configured to receive broadcast media streams. As shown in FIG. 1, receiving device 100 includes processor 105 coupled to media input 110, media output 115, network interface 120, memory 125 and user input 130. In one embodiment, media input 110 may comprise one or more terminals to receive a broadcast media stream. It may also be appreciated that media input 110 may be configured to receive a broadcast media stream from one or a wired and/or wireless source. Further, audio data comprising audio data associated with at least one language per channel of the broadcast media stream may be received by media input 110. It may also be appreciated that media input 110 may be configured to receive audiovisual signals from one or more external devices. Media output 115 may comprise one or more terminals to output media to an external device. In certain embodiments, when receiving device 100 relates to a set-top box, media output 115 may be coupled to a display device. In that fashion, receiving device 100 can output audiovisual data using media output 115 to a display device. According to another embodiment, media input 110 and media output 115 may be combined into a single input/output circuit.

According to another embodiment, receiving device 100 may relate to one or more of a television, monitor, computer display and display device in general. As such, receiving device 100 may comprise display 145 for outputting received video and/or visual media. In one embodiment, display logic 135 of processor 105 may include one or more instructions to output signals to display media data received by media input 110 for presentation on display 145. Similarly, receiving device 100 may comprise optional audio output 150 for outputting received audio. In one embodiment, audio logic 140 of processor 105 may be configured to output one or more audio signals received by media input 110 to optional audio output 150. Audio output 150 may relate to one of a speaker and audio output device in general. Processor 105 can be any type of processor such as a microprocessor, field programmable gate array (FPGA) and/or application specific integrated circuit (ASIC). It may also be appreciated that processor 105 may be configured to provide a graphical user interface (GUI) to receive one or more settings from a user of receiving device 100. Further, receiving device 100 may employ optional display 145 to display a GUI. According to one embodiment, user input 130 may comprise one or more terminals to receive commands from a user of the receiving device 100. Further, user input 130 may comprise a wireless receiver to receive commands from a user of the receiving device 100 employing a remote transmitter.

According to another embodiment, audio logic 140 may comprise one or more executable instructions to decode audio data within a broadcast media stream received by receiving device 100. In one embodiment, audio logic 140 may include one or more instructions to select and output an audio language associated with a channel of the broadcast media stream. It may be appreciated that outputting media with a selected language by receiving device 100 may be based on one or more user settings. Audio logic 140 may be configured to output audio data for each channel related to music, effects, commentary, etc. In that fashion audio logic 140 can provide multichannel audio, such as surround sound, 5.1 channel audio and/or multichannel audio in general.

According to another embodiment, receiving device 100 may be configured to receive a user request to set one or more audio language settings. In one embodiment, receiving device 100 may be configured to allow a user to set a user interface language. As such, receiving device 100 may be configured to display text and output media in a single spoken language. In another embodiment, one or more inputs of user input 130 may be employed to enter user preferences into receiving device 100, such as a preferred language. In certain embodiments, audio logic 140 may be configured to recognize user preferences based on received commands. A user preference may indicate a preferred language and/or preferred audio data for a channel that may be different from a language setting of receiving device 100 according to another embodiment. User input 130 may additionally be employed by a user to issue commands for receiving device 100. Audio language settings entered by a user may be stored by memory 125. It may be appreciated that memory 125 may relate to any type of memory, such as ROM or RAM memory. In certain embodiments, audio logic 140 may be configured to set/remove audio language settings based on one or more received settings.

In one embodiment, receiving device 100 may be configured to communicate over a data communication network using network interface 120. In another embodiment, receiving device 100 may communicate with a server via network interface 120 to request and/or receive audio data as will be described below in more detail.

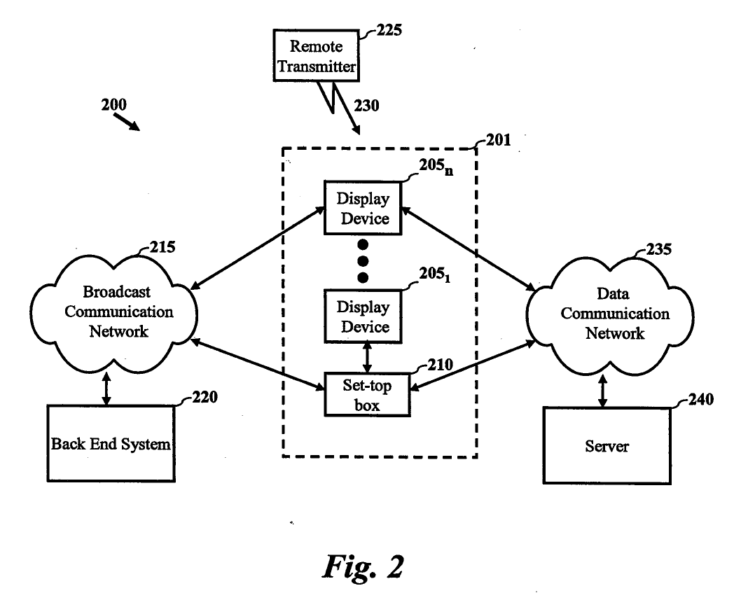

Referring now to FIG. 2, a simplified system diagram is shown of a system according to one or more embodiments of the invention. In one embodiment, system 200 may be configured to provide broadcast media streams to one or more receiving devices 201 (e.g., receiving device 100). It may be appreciated that receiving devices 201 may comprise one or more of display devices 205₁₋ₙ and set top box 210. As shown in FIG. 2, system 200 comprises a plurality of display devices 205₁₋ₙ which can receive one or more broadcast media streams from backend system 220 via broadcast communication network 215. Backend system 220 and broadcast communication network 215 may be used to provide media corresponding to a multitude of forms (e.g., Digital Satellite System (DSS), Digital Broadcast system (DBS), Advanced Television Standards Committee (ATSC), Internet Protocol Television (IPTV), etc.). It may also be appreciated that backend system 220 may be configured to transmit live and/or pre-recorded media.

According to another embodiment, broadcast communication network 215 may relate to one of a wired and wireless networks. As such, communication links shown in FIG. 2, may correspond to one or more of a telephone line, coaxial line, a fiber optic data line and radio frequency (RF) links. According to another embodiment, broadcast communication network 215 may be configured to transmit additional data in conjunction with, or separately from, media transmitted by broadcast communication network 215. In an exemplary embodiment, alternate audio language data may be transmitted by broadcast communication network 215.

In certain embodiments, display devices 205₁₋ₙ may interoperate with a set-top box to receive media from a broadcast communication network 210. As shown in FIG. 2, set-top box 210 may be configured to decode received media streams for display device 205₁. In one embodiment, set-top box 210 may correspond to one of a set top box, satellite receiver, television tuner and any television middleware device in general. It may also be appreciated that set-top box 210 may be configured to provide an interface for a data communication network 235. According to another embodiment, display devices 205₁₋ₙ may receive media from a media player (not shown) coupled to a media input (e.g., media input 110) of the display devices.

According to another embodiment, receiving devices 201 of system 200 may be configured to interoperate with remote transmitter 225. Remote transmitter 225 may be utilized by a user for operation of one or more receiving devices 201. Remote transmitter 225 may be configured to transmit one or more wireless controller signals, shown as 230, to receiving devices 201. According to another embodiment, a user may operate remote transmitter 225 to transmit one or more user preferences to receiving devices 201. It may also be appreciated that remote transmitter 225 may include one or more inputs (not shown) to select a preferred audio language of a received broadcast stream. In certain embodiments, remote transmitter 225 may include a dedicated input to select a preferred language of a received broadcast media stream.

Continuing to refer to FIG. 2, display devices 205₁₋ₙ and/or set top box 210 may communicate with server 240 via a data communication network 235. In one embodiment, server 240 may relate to one of a personal computer, mobile device, server and personal computing device in general. According to another embodiment, data communication network 235 may be configured to provide network communication capability for display devices 205₁₋ₙ and/or set-top box 210. Further, display devices 205₁₋ₙ can provide an internet interface for users. In another embodiment, display devices 205₁₋ₙ can interoperate with a network interface (not shown) to receive data. System 200 may be configured to support network browsing, downloads, and/or streaming of content at display devices 205₁₋ₙ such as music videos, movie trailers, user-generated videos, personalized weather, traffic feeds, map applications, etc. In a similar fashion, set-top box 210 may be configured to received network information. In one embodiment, media may relate to live broadcasts and/or pre-recorded media. In certain embodiments, a network interface (e.g., network interface 120) may be embodied in display devices 205₁₋ₙ and/or set-top box 210 for communication over data communication network 235. It may also be appreciated that audio decoding functions of display devices 205₁₋ₙ and set top box 210 may request audio data for a received media broadcast from server 240. For example, when a preferred audio language is not present in a received media broadcast stream receiving devices 201 may be configured to request audio data from server 240.

Referring now to FIG. 3, process 300 is shown for selecting audio of a received broadcast stream by a receiving device (e.g., receiving device 100) according to one or more embodiments. In one embodiment, process 300 may be performed by a processor (e.g., processor 105) of the receiving device. Process 300 may be initiated by receiving a broadcast media stream by the receiving device at block 305. In one embodiment, the received broadcast media stream may relate to a DTV stream. It may also be appreciated that the received broadcast media stream at block 305 can include video data and audio data. In another embodiment, the received broadcast media stream at block 305 may include a program channel map to describe video and audio services available for decoding. In certain embodiments, the channel map may correspond to a table, or list, defining elements of a DTV service according to the program and system information protocol (PSIP). Further, each packet of the broadcast media stream may be identified by a packet identifier (PID), as will be described in more detail below with respect to FIG. 5. At block 310, a channel setting may be detected for the receiving device. The channel setting may relate to at least one of a virtual channel and physical channel of the received broadcast media stream. In certain embodiments, the receiving device may have been previously set to a channel stored by a memory (e.g., memory 125) of the receiving device.

At block 315, the processor can determine an audio language setting associated with the channel setting detected at block 310. In one embodiment, the receiving device may store user settings for a particular channel. For example, a user may request that a particular audio language and/or audio channel be decoded from received broadcast signals. Settings of the of the receiving device may be stored by a memory (e.g., memory 135) of the receiving device. Detecting the audio language setting at block 315 may comprise parsing a program identifier of a channel map associated with the received broadcast media stream. According to one embodiment, detecting an audio language setting at block 315 may be based on an index number stored in a channel map, wherein the index number identifies user preferred audio data. At block 320, the processor can output received media with audio based on the user's preferred language setting. In one embodiment, the processor of the receiving device may decode audio data associated with a user's preferred language from the received media broadcast signal. Decoding of the audio data may be based on a PID corresponding to audio data for a user's preferred language. In another embodiment, the receiving device may request audio data for a user's preferred language over a data communication network (e.g., data communication network 235) to output media having a particular audio language. Outputting data at block 320 may comprise outputting audio data for one or more of sound effects, music and multichannel audio based on a PID detected at block 315. According to another embodiment, outputting of the media at block 320 may include synchronizing audio data associated with the users preferred audio language with the video data.

In another embodiment, outputting of video and audio data at block 320 may be based on a type of the received media. By way of example, process 300 may include detecting advertisements and/or promotional content of a received broadcast stream. Further, based on a type of media received, alternate audio languages may be output. In yet another embodiment, volume levels associated with received audio data may be adjusted based on a type of received media. By way of example, some users may recognize the advantage of muting audio for commercials.

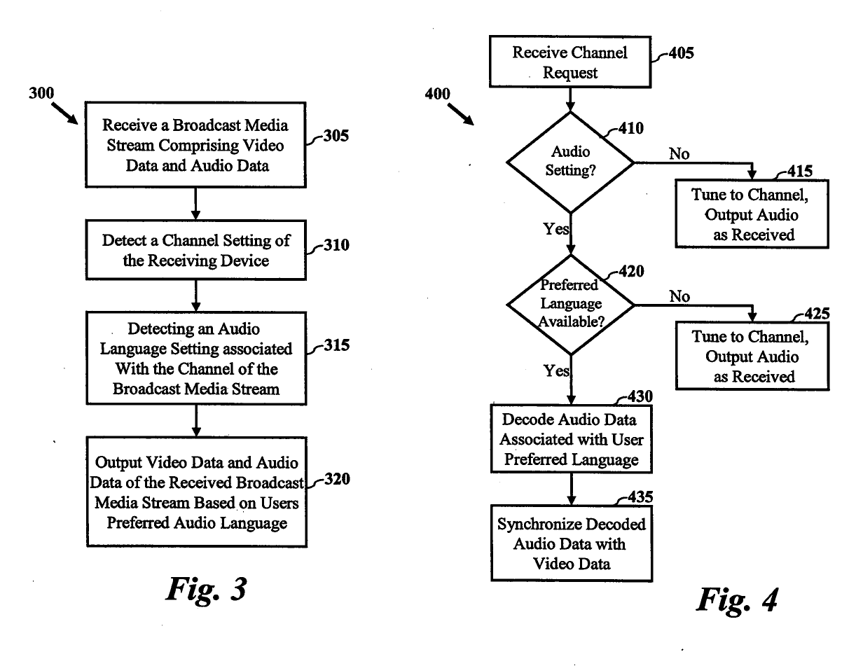

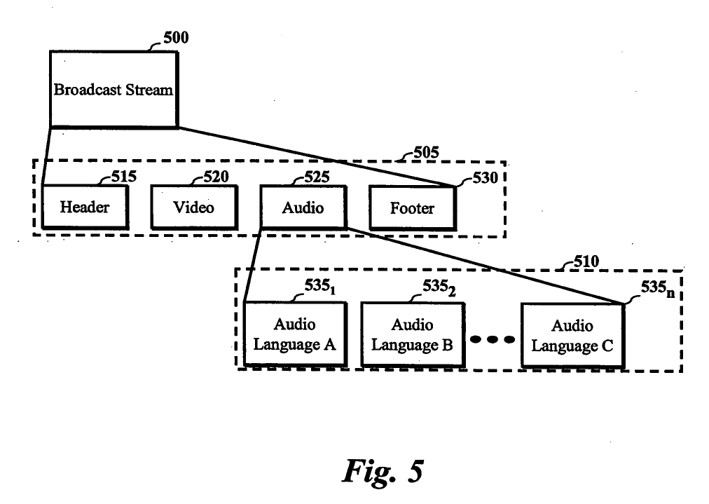

Referring now to FIG. 4, a process is shown for providing audio for a receiving device (e.g., receiving device 100) according to one or more embodiments of the invention. Process 400 may be initiated by receiving a channel request to tune the receiving device to a particular channel setting at block 405.

In one embodiment, a user can initiate a request to set an audio language using a terminal of the display device (e.g., display device 205₁₋ₙ) and/or a remote transmitter (e.g., remote transmitter 225). In certain embodiments, the user can navigate a user interface menu of the receiving device to set and/or remove audio language settings. The receiving device can check for audio settings for the desired channel at decision block 410. In one embodiment, audio settings may be based on a user requesting to modify an audio language setting for a channel of the broadcast media stream. In one embodiment the receiving device may be configured to store the audio language setting in a program identifier of the channel map of the received broadcast data. For example, the audio language setting may relate to a different language selection and/or index number in a channel map identifying a one or more PIDs corresponding to desired audio data. When there is no audio setting stored (“No” path out of decision block 410), the receiving device may tune to the channel at block 415 and decode audio data associated with the channel in the normal course. For example, audio data associated with the channel map be based on a menu setting of the receiving device.

In another embodiment, when audio setting exists for the particular channel (“Yes” path out of decision block 410) the receiving device can detect if audio data associated with a user's preferred language setting is available at decision block 420. When there is no audio data provided by a received broadcast media stream associated with a user's preferred language (“No” path out of decision block 420), the receiving device may tune to the channel at block 425 and decode audio associated with the channel. According to another embodiment, when there is no audio data provided by a received broadcast media stream associated with a user's preferred language, the receiving device can request audio language data over a data communications network using a network interface (e.g., network interface 120).

According to another embodiment, when an audio data for a users preferred language setting is received with a broadcast media stream (“Yes” path out of decision block 420) the receiving device can decode audio data associated with a user's preferred language setting at block 430. In one embodiment, the receiving device can parse a channel map of the received broadcast data stream to detect a program identifier for identifying a user's preferred audio language setting. At block 435, the receiving device may synchronize decoded audio data with received video data. While process 400 has been described for receiving devices, it should also be appreciated that the process may be similarly performed by other devices.

Referring now to FIG. 5, a graphical representation is shown of an exemplary broadcast media stream. Broadcast media stream 500 may include a plurality of physical and/or virtual channels. As used herein, a physical channel relates to a specific frequency range of the broadcast media stream. Alternatively, a virtual channel relates to a channel designation which differs from the physical channel and/or frequency on which the signal travels. As shown in FIG. 5, broadcast media stream 500 comprises at least one channel, shown as 505. It may be appreciated that channels of broadcast media stream 500 may include content having one or more languages. According to another embodiment, broadcast media stream 500 may relate to one or more standards, such as Digital Satellite System (DSS), Digital Broadcast system (DBS), Advanced Television Standards Committee (ATSC), Internet Protocol Television (IPTV), etc.)

In one embodiment, channel 505 may comprises header information 515, video data 520, audio data 525 and footer data 530. In one embodiment, header information 515 and footer information 530 may provide data for decoding media provided in channel 505. It may also be appreciated that program map information may be transmitted in header information 515. According to another embodiment, channel 505 may be transmitted as packets, wherein each packet comprises a packet identifier (PID). Video data 520 may comprise data to be provided by a display device. Audio data 525 may comprise audio data for one or more audio services which may be provided based on broadcast media stream 500, including music, effects, dialogue, captioning, etc. According to another embodiment, audio data 525 may comprise audio language data 510. Audio language data 510 may comprise to a plurality of audio languages 535₁₋₂ which may be provided with video data of the broadcast stream. In yet another embodiment, broadcast stream 500 may comprise a channel map (not shown) that describes video data and audio data available for decoding. It may also be appreciated that the channel map may comprise an index number to identify an audio channel. According to another embodiment, audio data may be decoded based on one or more PIDs.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for providing an alternate audio language for a received broadcast media stream, the method comprising the acts of:
receiving a broadcast media stream, by a receiving device, comprising video data and audio data;
detecting a channel setting of the receiving device, the channel setting comprising audio data in a plurality of audio languages and associated with a channel of the broadcasted media stream;
detecting an audio language setting associated with the channel of the broadcast media stream, wherein the audio language setting corresponds to a user preferred audio language for the channel; and
outputting the video data and the audio data of the received broadcast media stream based, at least in part, on the user preferred audio language.

2. The method of claim 1, wherein the broadcast media stream relates to one of Digital Satellite System (DSS), Digital Broadcast system (DBS), Advanced Television Standards Committee (ATSC), Internet Protocol Television (IPTV) and digital television stream in general.

3. The method of claim 1, wherein the channel setting relates to one of a virtual channel and physical channel of the received broadcast media stream.

4. The method of claim 1, wherein detecting the audio language setting comprises parsing a program identifier of a channel map associated with the received broadcast media stream for the user preferred audio language.

5. The method of claim 1, wherein outputting the video data and audio data comprises synchronizing audio data associated with the user preferred audio language with the video data.

6. The method of claim 1, further comprising receiving a request to modify the audio language setting for the channel of the broadcast media stream, and storing an updated audio language setting in a program identifier of a channel map of the received broadcast data.

7. The method of claim 1, further comprising adjusting a volume level associated with the audio data based on a type of received media.

8. A consumer device configured for providing an alternate audio language for a received broadcast media stream, the consumer device comprising:
an input terminal configured to receive a broadcasted media stream;
an output terminal configured to output audio data and video data; and
a processor coupled to the input and output terminals, the processor configured to:
detect a channel setting of the receiving device, the channel setting comprising audio data in a plurality of audio languages and associated with a channel of the broadcasted media stream;
detect an audio language setting associated with the channel of the broadcast media stream, wherein the audio language setting corresponding to a user preferred audio language for the channel; and
output the video data and the audio data of the received broadcast media stream based, at least in part, on the user preferred audio language.

9. The consumer device of claim 8, wherein the broadcast media stream relates to one of Digital Satellite System (DSS), Digital Broadcast system (DBS), Advanced Television Standards Committee (ATSC), Internet Protocol Television (IPTV) and digital television stream in general.

10. The consumer device of claim 8, wherein the channel setting relates to one of a virtual channel and physical channel of the received broadcast media stream.

11. The consumer device of claim 8, wherein detecting the audio language setting comprises parsing a program identifier of a channel map associated with the received broadcast media stream for the user preferred audio language.

12. The consumer device of claim 8, wherein outputting the video data and audio data comprises synchronizing audio data associated with the user preferred audio language with the video data.

13. The consumer device of claim 8, wherein the processor is further configured to receive a request to modify the audio language setting for the channel of the broadcast media stream, and store the updated audio language setting in a program identifier of a channel map of the received broadcast data.

14. The consumer device of claim 8, wherein the processor is further configured to adjust a volume level associated with the audio data based on a type of received media.

15. The consumer device of claim 8, wherein the consumer device relates to one of a display device, set-top box and middleware device in general.

16. A method for providing alternate audio data for a received broadcast media stream, the method comprising the acts of:
receiving a broadcast media stream, by a receiving device, comprising video data and audio data;
detecting a channel setting of the receiving device, the channel setting comprising audio data in a plurality of audio channels and associated with a channel of the broadcasted media stream;
detecting an audio channel setting associated with the channel of the broadcast media stream, wherein the audio channel setting corresponds to a user preferred audio data for the channel; and
outputting the video data and the audio data of the received broadcast media stream based, at least in part, on the user preferred audio data for the channel.

17. The method of claim 16, wherein the broadcast media stream relates to one of Digital Satellite System (DSS), Digital Broadcast system (DBS), Advanced Television Standards Committee (ATSC), Internet Protocol Television (IPTV) and digital television stream in general.

18. The method of claim 16, wherein the channel setting relates to one of a virtual channel and physical channel of the received broadcast media stream.

19. The method of claim 16, wherein detecting the audio data setting comprises parsing an index number of a channel map associated with the received broadcast media stream for the user preferred audio data.

20. The method of claim 16, wherein outputting the video data and audio data comprises synchronizing audio data associated with the user preferred audio language with the video data.

21. The method of claim 16, further comprising receiving a request to modify the audio data setting for the channel of the broadcast media stream, and storing an updated audio data setting in a program identifier of a channel map of the received broadcast data.

22. The method of claim 16, further comprising adjusting a volume level associated with the audio data based on a type of received media.

23. The method of claim 16, further comprising:
detecting an audio language setting associated with the channel of the broadcast media stream, wherein the audio language setting corresponds to a user preferred audio language for the channel; and
outputting the video data and the audio data of the received broadcast media stream based, at least in part, on the user preferred audio language.
